(19) United States
(12) Patent Application Publication
(10) Pub. No.: US 2026/0337346 A1
(43) Pub. Date: Oct. 29, 2026

(54) HYDROTHERMAL CARBON NANOTUBE -POLYMER COMPOSITES

(71) Applicant: Worcester Polytechnic Institute, Worcester, MA (US)

(72) Inventors: Madison Reed, Worcester, MA (US); Michael T. Timko, Arlington, MA (US)

(21) Appl. No.: 19/575,143

(22) Filed: Mar. 23, 2026

Related U.S. Application Data
(60) Provisional application No. 63/775,678, filed on Mar. 21, 2025.

(51) Int. Cl. C08J 3/205; C08K 3/04

(52) U.S. Cl. CPC C08J 3/205; C08K 3/041; C08J 2323/00; C08K 2201/011

(57) ABSTRACT

A material synthesis process strengthens polymers, particularly for molding processes, by swelling the polymer matrix to increase chain mobility and allow CNTs to migrate into the matrix for strengthening the molded article. Application of pressure and heat in a containment environment with water imparts hydrothermal activity that increases an ability of water to operate as a solvent for mixing the CNT structures into the polymer strands, and also mitigates a shear effect from agitation in mixing and combining the superheated water, CNT and polymer mix. Conditions borrowed from hydrothermal liquefaction (HTL) increase an affinity of the polymer for the water to facilitate a nondestructive, ordered alignment of the CNTs within the polymer matrix. Maintaining a temperature below a thermal degradation level avoids the entropy and material breakdown commonly associated with HTL, and instead decreases entropy by providing an ordered integration of CNT strengthening into a molded polymer.

### RELATED APPLICATIONS

This patent application claims the benefit under 35 U.S.C. § 119(e) of U.S. Provisional Patent App. No. 63/775,678, filed Mar. 21, 2025, entitled “HYDROTHERMAL CNT POLYMER COMPOSITES,” incorporated herein by reference in entirety.

### BACKGROUND

Carbon based materials such as carbon fibers, carbon black and carbon nanotubes (CNTs) have beneficial strength properties that can enhance existing materials using appropriate synthesis. CNT-polymer composites, for example, bring together the ductile properties of polymers with conductivity and strength that is often reserved for metals. As such, these materials are considered engineering plastics which are often expensive to manufacture and difficult to process, involving specialized and volatile solvents with corresponding handling complexities and disposal issues.

### SUMMARY

A material synthesis process strengthens polymers, particularly for molding processes, by swelling the polymer matrix to increase chain mobility and allow CNTs to migrate into the matrix for strengthening the molded article. Application of pressure and heat in a containment environment with water imparts hydrothermal activity that increases an ability of water to operate as a solvent for mixing the CNT structures into the polymer strands, and also mitigates a shear effect from agitation in mixing and combining the superheated water, CNT and polymer mix. Conditions borrowed from hydrothermal liquefaction (HTL) increase an affinity of the polymer for the water to facilitate a nondestructive, ordered alignment of the CNTs interspersed within the polymer matrix. Maintaining a temperature above a polymer melting point but below a thermal degradation level avoids the entropy and material breakdown commonly associated with HTL, and instead decreases entropy by providing an ordered integration of CNT strengthening into a molded polymer.

Configurations herein are based, in part, on the observation that carbon nanotubes (CNT) provide an efficient, low cost enhancement to the strength of synthesized materials such as polymers. Unfortunately, conventional approaches to CNT integration suffer from the shortcoming that properly dispersing CNTs thought a polymer matrix can be problematic, requiring specialized and often volatile and/or hazardous solvents, and/or adding functional groups to the CNTs. Accordingly, configurations herein substantially overcome the shortcomings of conventional approaches by incorporating a hydrothermal treatment that effectively employs water as a solvent under high temperate and pressure to swell the polymer matrix and distribute the CNTs in a structurally beneficial and aligned manner to form a polymer/CNT that avoids compromising the polymer strands by shear force from the composite blending. Conventional approaches agitate, blend, or force polymers and CNTs in a manner that can tend to shear the polymer strands and/or the tubular structure of the CNTs. The swelling of the polymer matrix allows greater motility of the CNTs to move around and adjacent to the polymer strands during mixing and/or screw forced injection as often employed for polymer molding.

The disclosed approach utilizes insights gained from both melt and solution blending to enable a low-carbon method for CNT-polymer composite synthesis. By using a lower shear environment than melt blending, configurations herein preserve molecular integrity of the polymer chains and limit degradation. Instead of dissolving the polymers and CNT in respective solvents and combining them as done in solution blending, the disclosed approach can exploit the solubility differences to beneficially drive CNT dispersion. Hydrothermal water swells the polymer matrix and enables chain relaxation allowing for additive incorporation. Then, as CNTs are generally insoluble in water, this change in chain relaxation makes it more energy favorable for CNTs to be incorporated into the polymer. Through precise process controls, a moderate stirring rate is employed to enable good dispersion of CNTs.

In further detail, a polymer composite synthesis approach forms a reinforced polymer by combining a polymer defining a polymer matrix, carbon nanotubes (CNT) and water in a containment, and heating the containment under pressure to a temperature greater than the melting point of the polymer and less than a degradation temperature of the polymer. Maintaining the pressure in the containment increases a solubility of the CNTs in the polymer for swelling the polymer matrix to disperse the CNTs through the polymer matrix.

### BRIEF DESCRIPTION OF THE DRAWINGS

The foregoing and other objects, features and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a context diagram of a materials development environment suitable for use with configurations herein;

FIG. 2A-2B show a Hansen solubility analysis of the CNT polymer composite of FIG. 1;

FIGS. 3A-3C show microscope images of processed single walled carbon nanotubes (SWCNT);

FIGS. 4A-4C show microscope images of refined single walled carbon nanotubes (SWCNT);

FIG. 5 shows conductivity of the processed and refined CNT composite films;

FIG. 6 shows Raman spectroscopy of the processed and refined single-walled carbon nanotube composites; and

FIG. 7 shows thermogravimetric analysis of the processed and refined single-walled carbon nanotubes.

### DETAILED DESCRIPTION

The description below depicts an example formation of a polymer composite including CNTs in an environmentally favorable synthesis using water, one of the cheapest and most abundant solvents, to incorporate CNTs into commodity plastics to make the superior properties of these composites more accessible.

As the demand for advanced materials is continually growing with new technological developments, there has been a notable trend towards incorporating CNTs into polymer matrices. CNT-polymer composites are especially attractive as they combine the low cost, lightweight and durable properties of polymers with the impressive mechanical, electrical and thermal properties of CNTs. These composites are widely used within the energy, aerospace, defense, sporting goods, automotive and electronics industries. Advancing CNT polymer composites has the potential to create lightweight, structural materials for versatile applications such as battery components, circuitry, custom geometries in high strength structures, chemical and bio sensors, electromagnetic shielding and biomedical devices, to name several.

Conventional fabrication of CNT polymer composites is hindered by dispersion and alignment of CNTs within the polymer. Depending on the processing techniques these composites exhibit a wide range of properties due to the lack of control over CNT dispersion which has limited the development of scalable manufacturing processes for industrial production of composites. Accordingly, configurations herein employ a hydrothermal water-based approach to incorporate CNTs into commodity plastics for enhanced strength of bulk materials for 3D printing filaments and use in injection and compression molding.

CNT-polymer composites have the potential for a variety of applications due to the high electrical conductivity and strength of CNT. Conceptually, CNTs are a one-atom-thick layer of graphene rolled into a cylinder. This creates a long cylindrical structures of only a few nanometers in diameter composed of covalently bonded carbon atoms. The large surface to volume ratio of CNTs contribute to these unique mechanical, thermal and electrical properties. CNTs are most commonly synthesized through carbon-arc discharge, laser ablation, and chemical vapor deposition, for example. Two types of CNT can be made from these processes. Single-walled carbon nanotubes (SWCNT) is one layer of graphene and typically requires more costly, precision synthesis. Multi-walled carbon nanotubes (MWCNT) are multiple concentric tubes of graphene and can be easier to produce than SWCNT. SWCNTs however, have better material properties making them advantageous for many applications. Yet, to utilize these exceptional properties in composites, homogenous dispersion and good interfacial bonding between the polymer and the CNT need be attained.

CNT polymer composite manufacturing is generally achieved by three processes; solution blending, melt blending and in-situ polymerization. Of these methods solution and melt blending are the most widely accessible due to the tailored chemistries needed for polymerization. Solution blending allows for better control of CNT dispersion and alignment. However, difficulties arise in finding solvent compatibility, and evaporative fumes of many of the solvents needed are highly toxic. On the other hand, melt blending does not require any solvent use but due to the high shear environments degradation of the polymer chains can occur and less control is had over the dispersion and alignment of fibers. Therefore, configurations herein disclose an improved method which combines the principles of melt and solution blending to address these shortcomings.

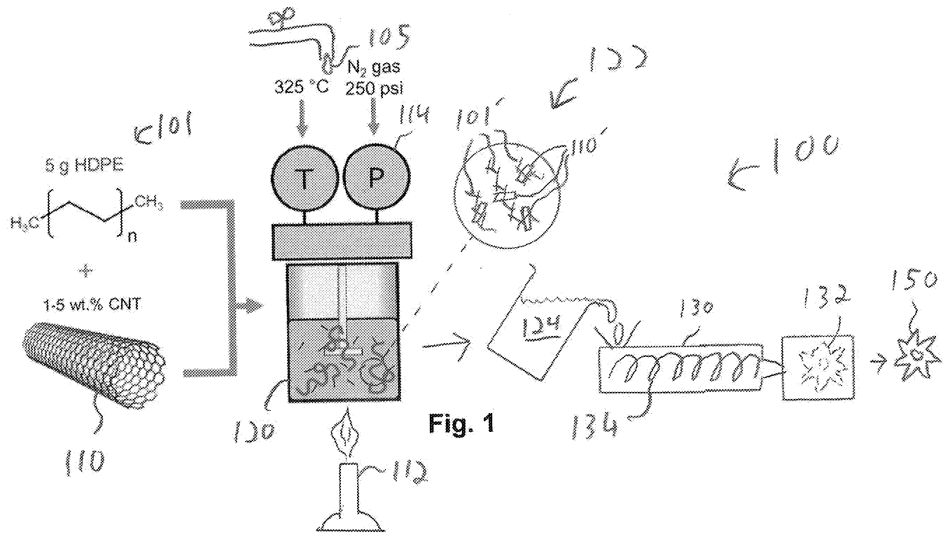

FIG. 1 is a context diagram of a materials development environment suitable for use with configurations herein. Referring to FIG. 1, the disclosed method 100 for forming a reinforced polymer 150 includes combining a polymer 101 defining a polymer matrix, carbon nanotubes (CNT) 110 and water 105 in a containment 120. A heat source 112 is used for heating the containment under a prescribed pressure 114 to a temperature greater than the melting point of the polymer 101 and less than a degradation temperature of the polymer. Polymers may be introduced as a granular or loose form, and CNTs are sourced from any suitable supply, discussed further below. Heat and pressure are maintained in the containment for swelling the polymer matrix 101′ to disperse the CNTs 110′ through the polymer matrix.

The heat and pressure in the containment 120 therefore have an effect of increasing a solubility of the CNTs 110′ in the polymer 101,′ as absent the high temperate and pressure of the hydrothermal water, blending and alignment of the CNTs interspersed among the polymer strands is problematic to achieve. The heat and pressure result in hydrothermal water dispersing the CNTs throughout the polymer matrix in a lower shear environment than a melt blending process alone, which tends to preserve the polymer chain structure and accordingly, the strength of the resulting reinforced polymer 150. The high heat of the water under pressure can allow the water to maintain a liquid state at the melting point of the polymer, well above the ambient atmospheric boiling point of water (100 °C). By generating hydrothermal water from the temperature and pressure in the containment, the hydrothermal water has a tendency to impart a solubility of the CNTs in the molten polymer 122 for infiltrating the CNTs in the polymer matrix.

In a particular configuration, the containment may be heated to between 250 °C-400 °C for between 5-30 minutes, and the pressure between 250 psi-2000 psi (about 1.4 MPa to 13.4 MPa, however pressures in the range of 15 MPa-20 MPa have been employed for maintaining the hydrothermal activity of the water. In general, hydrothermal temperature and pressure may employ temperatures in ranges up to 275 °C, 300 °C, 325 °C, 350 °C, 375 °C and 400 °C. Once the CNTs are distributed and aligned within the molten polymer, the resulting polymer composite yield 124 may be molded or formed by any suitable approach, such as an injection molding apparatus 130 for filling a mold 132. The resulting molded article 150 exhibits the strength of the distributed and aligned CNTs in the polymer matrix.

One of the advantages of the swelling of the polymer matrix is preventing shear (breaking) of the polymer chains and the CNTs. The pressurized heat and water provides the benefits of solution blending the CNTs 110′ into the polymer matrix 101′ using water 105 as a solvent, and prevents shearing of polymer strands of the polymer during the dispersal of the CNTs. Stirring and/or screw/impeller 134 feeding may occur in the molten polymer composite 124, for agitating the combination under pressure for forcing the combination into a mold 132, however the swollen polymer matrix 101′ helps prevent shearing of the polymer strands during the agitation.

In conventional approaches, the honeycomb like structure of CNTs make it extremely difficult to achieve good dispersion in various mediums due to the strong π-π interactions. These π-π bonds cause CNTs to form aggregates due to their large surface to volume ratio. Surface modification of CNTs has helped dispersion in polymers, however, these processes are not sustainable for bulk production as it requires tailoring for the specific polymer. These bonds (pi bonds) are covalent chemical bonds formed by the sideways or lateral overlap of two unhybridized orbitals on adjacent atoms. In chemistry terms, each of two lobes of an orbital on one atom overlap with two lobes of an orbital on another atom, and in which this overlap occurs laterally.

The process disclosed herein therefore merges aspects of both solvent blending and melt approaches. Different processes have been attempted to synthesize CNT composites. One common approach is solution processing in which polymers are dissolved in a suitable solvent, CNTs are mixed in the solution and the mixture is then cast into a film. This method offers good control over uniformity of CNT dispersion and is effective for a wide range of polymers. However, as discussed above, the solvents needed to dissolve polymers are often very toxic and as the solvent is evaporated through the film casting step, this process has a high environmental burden. Additionally, the mixing methods to disperse CNT, can shorten the nanotube length which is detrimental to the composite properties. Solution mixing also is less suitable for industrial scale processing. As such, melt blending processes are another very common method for CNT composite synthesis. Melt blending uses polymer processing equipment such as a twin screw extruder to mix melted polymer pellets and CNTs using high temperatures and shear forces. Although this process is both simple and scalable, the high shear forces needed to achieve uniform dispersion can cause fragmentation of CNTs leading to lower properties. In other approaches, in-situ polymerization methods have been explored to synthesize polymer grafted nanotubes. This technique is advantageous for polymers which are insoluble or thermally unstable and cannot be prepared through solution or melt blending processes. However, these processes can be limited to lower molecular weights as the viscosity of polymerization with CNTs increases significantly. Composites can have very uniform dispersion of CNT but poor alignment through this method leading to improved mechanical properties but poor electrical performance.

The fabrication of CNT polymer composites is hindered by dispersion and alignment of CNTs within the polymer. Depending on the processing techniques, these composites exhibit a wide range of properties due to the lack of control over CNT dispersion which has limited the development of scalable manufacturing processes for industrial production of composites. Of these methods solution and melt blending are the most widely accessible due to the tailored chemistries needed for polymerization. Solution blending allows for better control of CNT dispersion and alignment. However, difficulties arise in finding solvent compatibility and evaporation as many of the solvents needed are highly toxic. On the other hand, melt blending does not require any solvent use but due to the high shear environments, degradation of the polymer chains can occur and less control is maintained over the dispersion and alignment of fibers. Therefore, the configurations herein combine these principles of melt and solution blending to address the shortcomings of these conventional approaches.

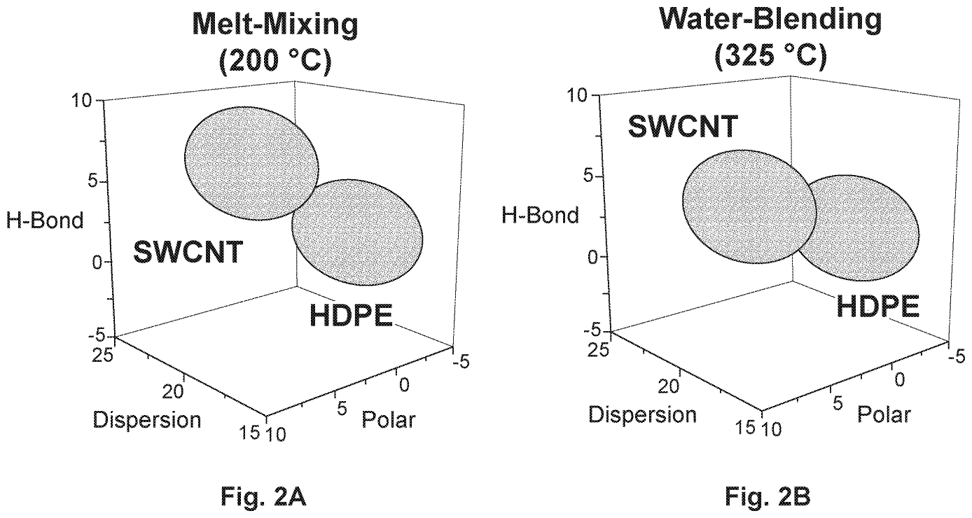

FIG. 2A-2B show a Hansen solubility analysis of the CNT polymer composite of FIG. 1. One reason conventional approaches fail is poor solubility of CNTs in solution and at the interface of the polymer. Hansen solubility parameters, HSPs, can provide thermodynamic insights to address this problem. As seen in FIGS. 2A-2B, the energy distance between the polymer and the CNT is reduced when using the water blending conditions of FIG. 2B when compared to melt-mixing conditions (FIG. 2A). This implies that solubility is increased under the elevated temperatures of water-blending which should lead to improved dispersion. Although the solubility increases with temperature, temperature must be balanced with preserving the polymer properties. In the water-based system, water and the low shear rate used were found to preserve the molecular weight. However, the melt-mixing system uses significantly higher shear rates, making these temperatures unachievable. The disclosed configuration aims to advance current practices for composite synthesis by providing a low-carbon processing alternative to incorporate the exceptional properties of CNTs into commodity polymers such as polyethylene and other polyolefins such as polypropylene (PP), commonly used in packaging, textiles, and consumer goods. Other suitable polymer structures may also benefit from the CNT composite insertion and alignment.

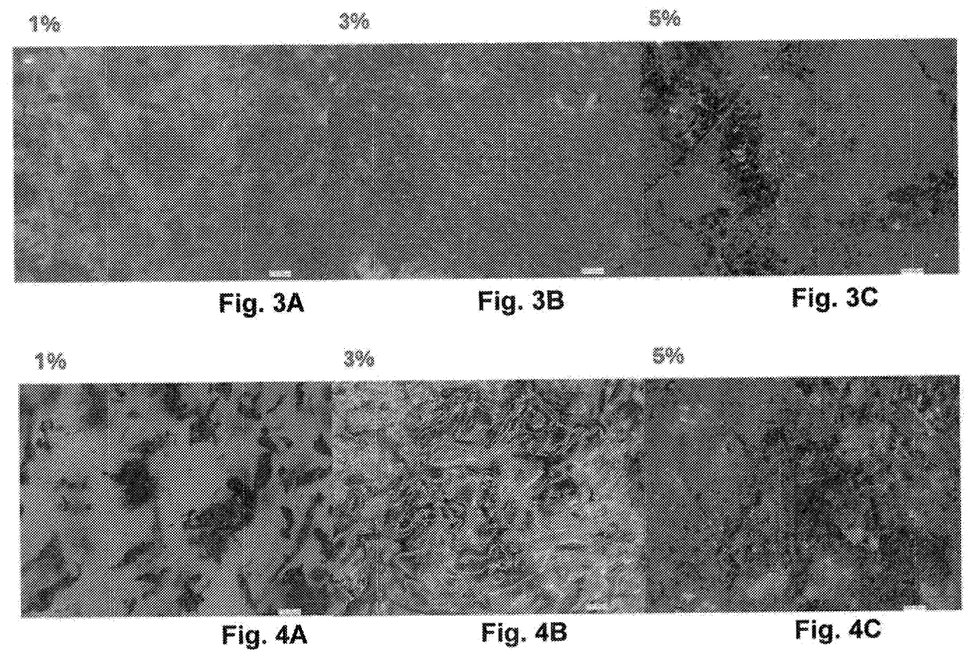

In a particular use case, several trials of sourced CNTs were employed. Commercial virgin HDPE (High-Density Polyethylene) was provided in the form of circular pellets. Experiments were carried out in a 150 mL Parr batch reactor vessel fitted with an impeller. SWCNTs were sourced from a first processed sample with up to 40% residual iron, and a more refined, second refined sample which has been further refined to remove iron content and reduce the D band (disorder or defect band), typically found near 1350 cm⁻¹ in Raman spectra, which is associated with defects in the sp² carbon network. FIGS. 3A-3C show microscope images of the first, processed SWCNT, and FIGS. 4A-4C show microscope images of the second refined CNTs.

Procedurally, batch experiments were performed with a four-blade Rushton style impeller stirred at a speed of 200 rpm. For each sample, approximately 5 g of plastic was added to the reactor vessel along with 1-5 weight percent of CNT and 15 mL of deionized water. Upon sealing the reactor vessel, it was pressurized with nitrogen gas and checked for gas leaks. Samples were then subjected to their respective thermal treatment and rapidly cooled with ice water once the set point was reached. During the cooling phase the impeller motor was turned off to prevent the solidifying plastic from entangling around the thermocouple.

The various loadings include 1%, 3% and 5% respectively for the processed (FIGS. 3A-3C) and refined (FIGS. 4A-4C) CNT. CNTs were incorporated into HDPE using water treatment at 325 °C. Composites were recovered following treatment and melt compressed into films.

Continuing to refer to FIGS. 3A-3C (processed SWCNT) and 4A-4C (refined SWCNT), visually the processed composites seem to have better dispersion than composites synthesized with the refined SWCNTs. In the refined composites, the visual dispersion increases as expected with loadings of 1-3%. (FIGS. 4A, 4B). Dispersion continues as expected at 5%, with refined CNT dispersing throughout the bulk material but still forming aggregates as seen in 1-3% DPT loadings. The processed composites of FIGS. 3A-3C appear to have slightly better dispersion with fewer visible aggregates in the bulk samples. Dispersion seems to increase linearly with processed CNT loading, leading to darker colored samples towards the 5% loading. No degradation of CNTs could be seen from microscope imaging as the length of untreated CNTs are approximately 700 nm.

Films were then analyzed using Raman spectroscopy which showed significant CNT presence in both 5% processed (FIG. 3C) and refined (FIG. 4C) composites. The D/G ratio, or the disorder ratio, in refined films was higher than in processed films (0.092 vs. 0.067), despite the untreated CNTs having the opposite effect (0.337 refined vs. 0.906 processed). This further indicates that processed composites showed better dispersion and CNT incorporation than composites formed from refined CNTs.

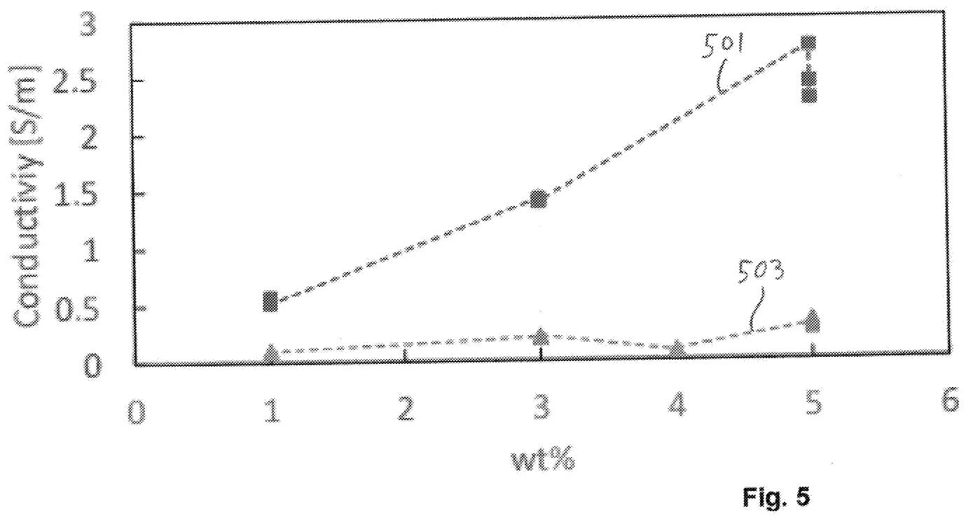

FIG. 5 shows conductivity of the processed 501 and refined 503 CNT composite films. Conductivity was measured using an Eddy current system which first measures the sheet resistance. Conductivity was then calculated from sheet resistance using:

$$σ = \frac{1}{{R}_{S} T}$$

### Where

σ is conductivity in S/m;
R_{S} is sheet resistance in kOhm/Sq; and
T is thickness calculated over 6 measurements

While composites are significantly less conductive than either CNT starting material, the processed films show higher conductivity than the refined. While neither film is highly conductive, they show higher conductivity than reported in conventional approaches for HDPE composites with similar CNT loadings. As both films exhibit variations of dispersed CNT dispersal and homogeneity, this indicates a beneficial distribution and alignment of the CNTs in the polymer composite. Although the processed CNTs are inherently less conductive, improved dispersion in the polymer composites contributed to an overall better conductivity.

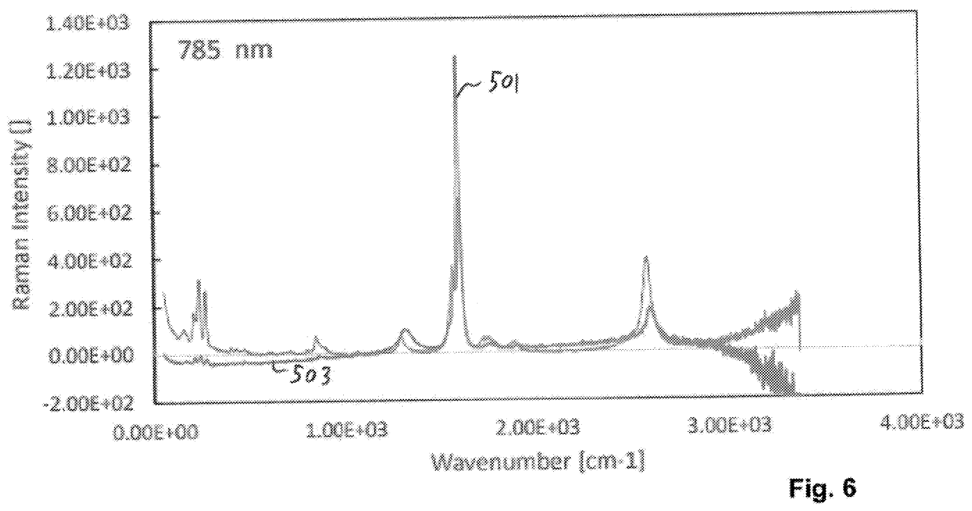

FIG. 6 shows Raman spectroscopy of processed 501 and refined 503 single-walled carbon nanotubes. A D/G ratio was calculated for processed and refined CNTs by taking the ratio of the D band, which is associated with structural defects in the sp2 carbon network located at approximately 1400 wavenumbers, and the G band, which represents the in-plane vibrations of sp2 carbon atoms located at approximately 1600 wavenumbers. The D/G ratio for refined CNT was calculated as 0.337 and 0.906 for processed, indicating the processed CNT has more disorder or defects than refined materials.

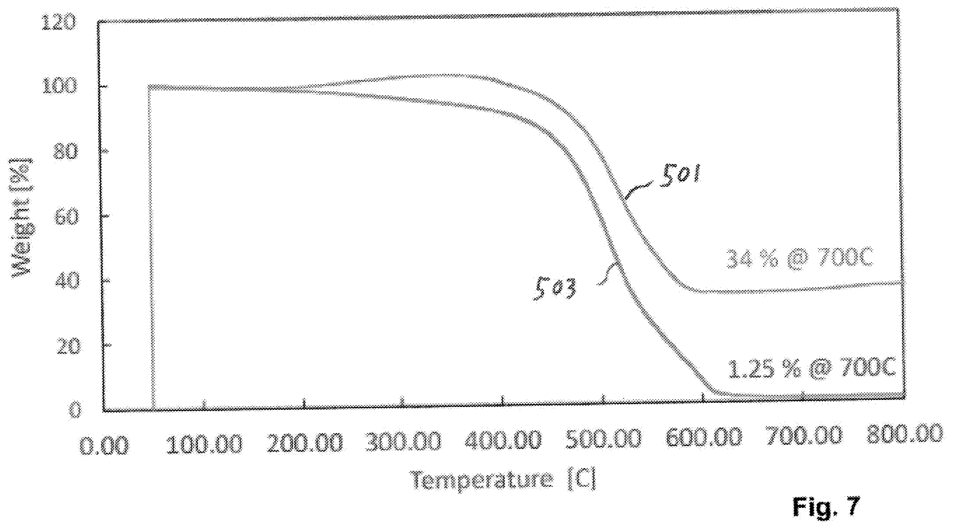

FIG. 7 shows thermogravimetric analysis of processed 501 and refined 503 single-walled carbon nanotubes. Processed and refined CNTs were analyzed by TGA to determine the residual impurity content. processed CNTs had a residual iron/iron oxide content of 35% whereas refined CNTs contained less than 2% residual iron content.

Configurations discussed above present a new method for sustainable synthesis of CNT-polymer composites. Composites were synthesized using 1-5 wt. % loadings of CNT in HDPE and subjected to treatment with water at around 325 °C. Interestingly, the lower quality CNT, APT, showed better dispersion and conductivity than the more refined DPT CNT. Conductivity of samples was low, yet higher than values reported in literature for HDPE nanocomposites synthesized through traditional means. Future work should be done to improve the dispersion and alignment of CNTs, in turn improving the properties. One path for improvement can be evaluated by tailoring process controls such as reaction temperature, stirring speed or including any pretreatment steps. Additionally, other CNTs can be tested such as multiwalled powders, graphene, double walled CNT, and carbon 65 based structures and derivatives carbon and crystallization forms, such as a slurry of SWCNTs. This method successfully produced CNT-HDPE composites through the disclosed low-carbon impact/emission and low-shear method.

While the system and methods defined herein have been particularly shown and described with references to embodiments thereof, it will be understood by those skilled in the art that various changes in form and details may be made therein without departing from the scope of the invention encompassed by the appended claims.

What is claimed is:

1. A method for forming a reinforced polymer, comprising:
combining a polymer defining a polymer matrix, carbon nanotubes (CNT) and water in a containment;
heating the containment under pressure to a temperature greater than the melting point of the polymer and less than a degradation temperature of the polymer; and
maintaining the pressure in the containment for swelling the polymer matrix to disperse the CNTs through the polymer matrix.

2. The method of claim 1 further comprising maintaining the heat and pressure in the containment for increasing a solubility of the CNTs in the polymer.

3. The method of claim 2 wherein the heat and pressure result in hydrothermal water dispersing the CNTs throughout the polymer matrix in a lower shear environment than a melt blending process.

4. The method of claim 1 further comprising heating the water under pressure to maintain a liquid state at the melting point of the polymer.

5. The method of claim 1 further comprising generating hydrothermal water from the temperature and pressure in the containment, the hydrothermal water imparting a solubility of the CNTs in the polymer for infiltrating the CNTs in the polymer matrix.

6. The method of claim 1 further comprising solution blending the CNTs into the polymer matrix using water as a solvent.

7. The method of claim 1 further comprising preventing shearing of polymer strands of the polymer during the dispersal of the CNTs.

8. The method of claim 1 further comprising:
agitating the combination under pressure for forcing the combination into a mold; and
preventing shearing of the polymer strands during the agitation.

9. The method of claim 1 wherein the polymer further comprises a polyolefin.

10. The method of claim 1 further comprising heating the containment to between 250 °C-400 °C for between 5-30 minutes.

11. The method of claim 1 further comprising maintaining the pressure between 250 psi-2000 psi.

12. The method of claim 1 further comprising maintaining the pressure between 2-20 MPa.

13. The method of claim 1 further comprising an absence of a non aqueous solvent to the polymer.

14. The method of claim 1 further comprising an absence of an added functional group to the CNT.

15. A polymer composite compound, comprising:
a polymer defining a polymer matrix; and
carbon nanotubes (CNT) dispersed through the polymer matrix, the carbon nanotubes aligned in the polymer matrix from a temperature and pressure imparting a solvent property in the water for swelling the polymer matrix for a non-shearing dispersal of the CNTs through the polymer matrix.

16. The compound of claim 15 wherein the polymer, CNT and water are heated in a containment at a temperature of at least 250 °C at a pressure of at least 250 psi for 5 minutes or more.

17. The compound of claim 15 wherein the polymer, CNT and water are heated in a containment at a temperature of at least 325 °C at a pressure of at least 250 psi for at least 30 minutes.

18. The compound of claim 15 wherein the CNTs are single walled carbon nanotubes.

19. The compound of claim 15 wherein the polymer is a polyolefin.

20. The compound of claim 15 wherein the heat and pressure are maintained in the containment for increasing a solubility of the CNTs in the polymer.
